(19) United States
(12) Patent Application Publication
(10) Pub. No.: US 2014/0143316 A1
(43) Pub. Date: May 22, 2014

(54) METHOD, APPARATUS, AND SYSTEM FOR ACQUIRING OBJECT

(71) Applicant: Huawei Technologies Co., Ltd., Shenzhen (CN)

(72) Inventor: Yong Zhang, Shenzhen (CN)

(73) Assignee: Huawei Technologies Co., Ltd., Shenzhen (CN)

(21) Appl. No.: 14/106,499

(22) Filed: Dec. 13, 2013

Related U.S. Application Data
(63) Continuation of application No. PCT/CN2013/074653, filed on Apr. 24, 2013.

(30) Foreign Application Priority Data
Nov. 16, 2012 (CN) 201210464619.9

(51) Int. Cl. H04L 29/06

(52) U.S. Cl. CPC H04L 67/42
USPC 709/203

(57) ABSTRACT

The present invention discloses a method, an apparatus, and a system for acquiring an object. The method includes: receiving a request of a client, where the request includes identifier information of a target object requested by the client; determining, according to the identifier information of the target object, whether the target object has one or more associated objects; when the target object has one or more associated objects, adding association indication information to the target object, and sending the target object to the client; after finishing sending the target object, sending verification information to the client, so that the client verifies the associated objects of the target object according to the verification information; determining a target associated object from the associated objects according to verification result information of the client; and sending the target associated object to the client.

### CROSS-REFERENCE TO RELATED APPLICATIONS

This application is a continuation of International Patent Application No. PCT/CN2013/074653, filed on Apr. 24, 2013, which claims priority to Chinese Patent Application No. 201210464619.9, filed on Nov. 16, 2012, both of which are hereby incorporated by reference in their entireties.

### TECHNICAL FIELD

The present invention relates to the field of communications, and in particular, to a method, an apparatus, and a system for acquiring an object.

### BACKGROUND

In a communication model with a C/S (client/server) architecture, when a client requests an object from a server, the object requested by the client generally has a lot of associated objects, that is, various objects associated with the object requested by the client. For example, when the client requests a Web page, the client can acquire complete data of the Web page requested by the client only after acquiring all other information associated with the Web page (for example, data of sub-pages). The other information herein may be called associated objects herein. Therefore, the client needs to undergo a number of request-response processes between the client and the server before it can acquire the complete requested object. With the development of network technologies, communication between networks becomes more and more complex. Therefore, when the client requests an object, the number of requests and responses between the client and the server is also increasing. Considering the current limited bandwidth, this obviously increases the burden of the network, leading to a network communication delay.

To solve the above problem, the prior art generally uses a client caching technology, that is, some objects are temporarily stored on the client. When the client requests an object from the server, if the object requested by the client exists in the cache of the client, the client directly acquires the object from the cache.

However, during the implementation of the present invention, the inventor discovers that, according to the solution in the prior art, before the client directly uses an object in the cache, the client still needs to query the server whether the object expires, and then the client determines, according to a response sent by the server, whether to directly use the object in the cache. That is to say, according to the solution in the prior art, even if the object requested by the client exists in the cache of the client, several request-response processes are still needed between the client and the server. Therefore, by using the solution in the prior art, network data traffic will still increase, leading to a network communication delay.

### SUMMARY

Embodiments of the present invention provide a method, an apparatus, and a system for acquiring an object to reduce network data traffic and a network communication delay.

To achieve the foregoing objective, the embodiments of the present invention use the following technical solutions:

Ina first aspect, a method for acquiring an object according to an embodiment of the present invention includes:

receiving a request of a client, where the request includes identifier information of a target object requested by the client;

determining, according to the identifier information of the target object, whether the target object has one or more associated objects;

when the target object has one or more associated objects, adding association indication information to the target object, and sending the target object to the client, so that the client continues to wait for receiving data after receiving the target object;

after finishing sending the target object, sending verification information to the client, so that the client verifies the associated objects of the target object according to the verification information;

determining, according to verification result information of the client, a target associated object from the associated objects; and

sending the target associated object to the client.

With reference to the first aspect, in a first possible implementation manner, the determining, according to the request, whether the target object has one or more associated objects includes:

transferring the request to an upper layer application, so that the upper layer application determines, according to the identifier information of the target object, whether to invoke a predetermined interface; and determining, according to an invocation situation of the predetermined interface, whether the target object has one or more associated objects;

or, querying, according to the identifier information of the target object, for an association table used to store information of associated objects of the target object, and determining, according to a query result, whether the target object has one or more associated objects.

With reference to the first aspect or the first possible implementation manner of the first aspect, in a second possible implementation manner, the association indication information is located in a last frame of the target object; and the verification information of the associated objects includes address information and relative expiry time of the associated objects.

With reference to the first aspect or the first possible implementation manner of the first aspect, in a third possible implementation manner,

the verification result information includes address information of an associated object that does not need to be sent; and the determining, according to verification result information of the client, a target associated object from the associated objects includes:

removing, according to the verification result information, the associated object that does not need to be sent to the client from the associated objects, and determining a remaining associated object as a target associated object;

or, the verification result information includes address information of an associated object that needs to be sent; and the determining, according to verification result information of the client, a target associated object from the associated objects includes:

confirming, according to the address information of the associated object that needs to be sent, accuracy of the verification result information, and determining a target associated object from the associated objects according to a confirmation result.

In a second aspect, a method for acquiring an object according to an embodiment of the present invention includes:

sending a request to a server, where the request includes identifier information of a requested target object;

receiving a target object which is sent by the server after the server receives the request, where the target object carries association indication information, where the association indication information is used to indicate that the target object has one or more associated objects;

receiving verification information of the associated objects which is sent by the server;

verifying the associated objects according to the verification information, and sending verification result information to the server, so that the server determines a target associated object according to the verification result information; and

receiving the target associated object sent by the server.

Ina first possible implementation manner of the second aspect, the verification information of the associated objects includes address information and relative expiry time of the associated objects; and the verifying the associated objects according to the verification information includes:

determining, according to the address information of the associated objects, whether a corresponding associated object is temporarily stored locally;

if a corresponding associated object is temporarily stored locally and a sum of existence time of the corresponding associated object and relative expiry time of the corresponding associated object is greater than a current time, determining that the server does not need to send the corresponding associated object; or

if a corresponding associated object is temporarily stored locally and a sum of existence time of the corresponding associated object and relative expiry time of the corresponding associated object is less than a current time, determining that the server needs to send the corresponding associated object.

With reference to the second aspect or the first possible implementation manner of the second aspect, in a second possible implementation manner of the second aspect, the verification result information includes:

address information of a corresponding associated object that does not need to be sent by the server or address information of a corresponding associated object that needs to be sent by the server.

In a third aspect, a server according to an embodiment of the present invention includes:

a receiving unit, configured to receive a request of a client, where the request includes identifier information of a target object requested by the client;

a judging unit, configured to determine, according to the identifier information of the target object received by the receiving unit, whether the target object has one or more associated objects;

a sending unit, configured to: when the judging unit determines that the target object has one or more associated objects, add association indication information to the target object, and send the target object to the client, so that the client continues to wait for receiving data after receiving the target object; and after finishing sending the target object, send verification information to the client, so that the client verifies the associated objects of the target object according to the verification information; and

a selecting unit, configured to determine a target associated object from the associated objects according to verification result information of the client received by the receiving unit; where:

the sending unit is further configured to send the target associated object to the client according to a processing result of the selecting unit.

In a first possible implementation manner of the third aspect, the judging unit includes:

a transferring module, configured to transfer the request to an upper layer application, so that the upper layer application determines, according to the identifier information of the target object, whether to invoke a predetermined interface; and

a processing module, configured to determine, when the upper layer application invokes the predetermined interface, that the target object has one or more associated objects, and determine, when the upper layer application does not invoke the predetermined interface, that the target object does not have an associated object, where, when the upper layer application determines, according to the identifier information of the target object, that there are one or more associated objects, the upper layer application invokes the predetermined interface; and when the upper layer application determines, according to the identifier information of the target object, that there is no associated object, the upper layer application does not invoke the predetermined interface.

With reference to the third aspect, in a second possible implementation manner of the third aspect, the judging unit includes:

a querying module, configured to query, according to the identifier information of the target object, for an association table used to store information of associated objects of the target object; and

a processing module, configured to determine, according to a query result of the querying module, whether the target object has one or more associated objects.

With reference to the third aspect or the first or second possible implementation manner of the third aspect, in a third possible implementation manner of the third aspect, the selecting unit is specifically configured to:

when the verification result information includes address information of an associated object that does not need to be sent, remove, according to the verification result information, the associated object that does not need to be sent to the client from the associated objects, and determine a remaining associated object as a target associated object;

or, when the verification result information includes address information of an associated object that needs to be sent, confirm, according to the address information of an associated object that needs to be sent, accuracy of the verification result information, and determine a target associated object from the associated objects according to a confirmation result.

In a fourth aspect, a client according to an embodiment of the present invention includes:

a sending unit, configured to send a request to a server, where the request includes identifier information of a requested target object;

a receiving unit, configured to receive a target object which is sent by the server after the server receives the request, where the target object carries association indication information, where the association indication information is used to indicate that the target object has one or more associated objects; and receive verification information of the associated objects sent by the server; and

a processing unit, configured to verify the associated objects according to the verification information received by the receiving unit; where:

the sending unit is further configured to send verification result information to the server according to a verification result of the processing unit, so that the server determines a target associated object according to the verification result information; and

the receiving unit is further configured to receive the target associated object sent by the server.

Ina first possible implementation manner of the fourth aspect, the verification information of the associated objects includes address information and relative expiry time of the associated objects; and the processing unit includes:

a detecting module, configured to determine, according to the address information of the associated objects, whether the client temporarily stores a corresponding associated object;

a comparing module, configured to: when the detecting module determines that a corresponding associated object is temporarily stored, compare a sum of existence time of the corresponding associated object and relative expiry time of the corresponding associated object with a current time; and

a determining module, configured to: when the comparing module determines that the sum of the existence time of the corresponding associated object and the relative expiry time of the corresponding associated object is greater than the current time, determine that the server does not need to send the corresponding associated object; and when the comparing module determines that the sum of the existence time of the corresponding associated object and the relative expiry time of the corresponding associated object is less than the current time, determine that the server needs to send the corresponding associated object.

With reference to the fourth aspect or the first possible implementation manner of the fourth aspect, in a second possible implementation manner of the fourth aspect, the verification result information includes:

address information of a corresponding associated object that does not need to be sent by the server or address information of a corresponding associated object that needs to be sent by the server.

In a fifth aspect, a system for acquiring an object according to an embodiment of the present invention includes:

a server, including the apparatus for acquiring an object in the third aspect; and

a client, including the apparatus for acquiring an object in the fourth aspect.

By using the method, the apparatus, and the system for acquiring an object, after a server receives a request of a client, the server determines, according to the request of the client, whether a target object has one or more associated objects; when determining that the target object has one or more associated objects, the server adds association indication information to the target object, where the association indication information is used to indicate to the client that the target object has one or more associated objects. After receiving the target object that carries the association indication information and determining that the target object carries the association indication information, the client verifies the associated objects according to verification information of the associated objects which is sent by the server, and sends verification result information to the server, so that the server determines a target associated object according to the verification result information, and sends the target associated object to the client.

As can be seen from the foregoing process, when determining that the object requested by the client has one or more associated objects, the server adds association indication information to the object sent to the client to indicate to the client that the object requested by the client has one or more associated objects. Therefore, different from the prior art where the client needs to request associated objects from the server one by one, after acquiring the association indication information, the client verifies the associated objects according to the verification information of the associated objects of the server, and then the server determines a target associated object according to the verification result information, and sends the target associated object to the client. Therefore, by using the method, the apparatus, and the system according to the embodiments of the present invention, the number of requests-responses between the server and the client can be greatly reduced, thereby reducing the network data traffic and the network communication delay.

### BRIEF DESCRIPTION OF THE DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a flowchart of a method for acquiring an object according to Embodiment 1 of the present invention;

FIG. 2 is a flowchart of a method for acquiring an object according to Embodiment 2 of the present invention;

FIG. 3 is a flowchart of a method for acquiring an object according to Embodiment 3 of the present invention;

FIG. 4 is a schematic diagram of a server according to Embodiment 4 of the present invention;

FIG. 5 is a schematic diagram of a client according to Embodiment 5 of the present invention;

FIG. 6 is a schematic diagram of a system for acquiring an object according to Embodiment 6 of the present invention; and

FIG. 7 is a schematic structural diagram of a remote control device according to Embodiment 7 of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person skilled in the art based on the embodiments of the present invention without creative efforts shall fall within the protection scope of the present invention.

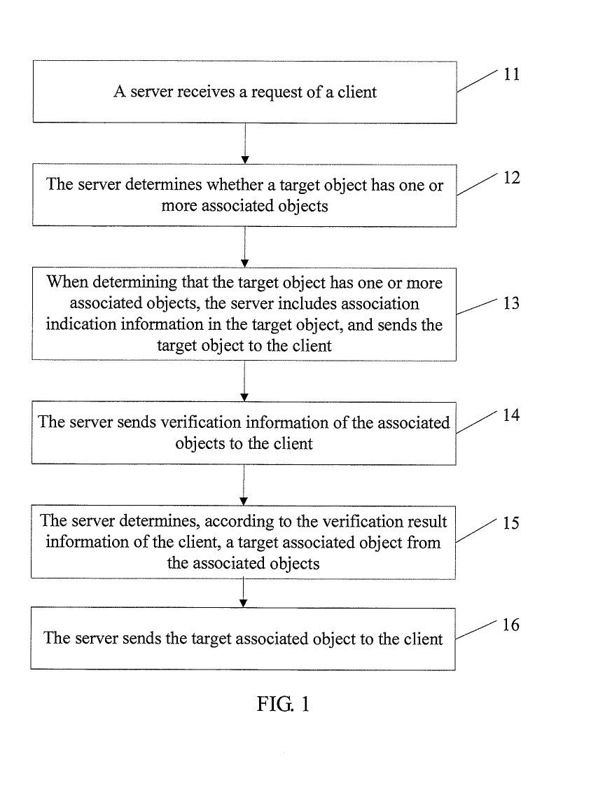

As shown in FIG. 1, a method for acquiring an object according to Embodiment 1 of the present invention includes the following steps:

Step 11: A server receives a request of a client, where the request includes identifier information of a target object requested by the client.

The identifier information of the target object requested by the client may be information that can identify the target object, for example, a name of the target object requested by the client.

Step 12: The server determines, according to the identifier information of the target object, whether the target object has one or more associated objects.

The server herein can determine, in at least the following two manners, whether the target object has one or more associated objects.

Manner 1: The server determines whether the target object has one or more associated objects in a passive discovery mode. That is, the server determines, according to a processing result of an upper layer application, whether the target object has one or more associated objects. In the embodiment of the present invention, a predetermined interface is provided between a software layer where the server is located and an upper layer application (for example, the application layer). After receiving the request of the client, the sever transfers the request to the upper layer application. Therefore, the server can acquire the identifier information of the target object carried in the request, and the upper layer application may also acquire the identifier information of the target object. The upper layer application determines, according to the identifier information of the target object, whether to invoke the predetermined interface. Specifically, the upper layer application determines whether there are one or more associated objects according to settings of the upper layer application. When determining, according to the identifier information of the target object, that there are one or more associated objects, the upper layer application invokes the predetermined interface. In this way, the server can determine, according to the information that the upper layer application invokes the predetermined interface, that the target object has one or more associated objects. Otherwise, the upper layer application does not invoke the interface, and the server can determine that the target object does not have an associated object.

Manner 2: The server queries, according to the identifier information of the target object, for an association table used to store information of associated objects of the target object, and determines, according to a query result, whether the target object has one or more associated objects.

Compared with the Manner 2, Manner 1 has better universality. In addition, in the embodiment of the present invention, there may be one or more associated objects.

Step 13: When the target object has one or more associated objects, the server adds association indication information to the target object, and sends the target object to the client, so that the client continues to wait for receiving data after receiving the target object.

The server sends, according to the request of the client, the target object to the client. When determining, according to the processing result of the upper layer application, that there are associated objects, the server adds association indication information to the target object. The association indication information is used to indicate to the client that the target object has one or more associated objects.

The association indication information may be located in any one frame of the target object. However, to ease the pressure of the client in searching the target object for the association indication information and increase the search efficiency, the association indication information may be located in a last frame of the target object.

If the target object carries the association indication information, the client continues to wait for next data sent by the server rather than sends another request to the server in the prior art.

Step 14: After finishing sending the target object, the server sends verification information to the client, so that the client verifies the associated objects of the target object according to the verification information.

In this step, the verification information of the associated objects includes address information and relative expiry time of the associated objects. The address information of an associated object is an abstract representation of storage location information of the associated object in the server. According to different manifestations of the associated objects, the address information of the associated objects has different manifestations. For example, if an associated object is a file, the address information of the associated object may be a storage path of the file.

Step 15: The server determines, according to the verification result information of the client, a target associated object from the associated objects.

After performing verification according to the verification information, the client sends verification result information to the server. The client may temporarily store some objects, where the temporarily stored objects may not have expired, or may have already expired. When the objects temporarily stored in the client have not expired, the server does not need to send these objects to the client again. Among these associated objects, associated objects really needed by the client are target associated objects herein. Therefore, the verification result information of the client may be address information of an associated object that does not need to be sent or address information of an associated object that needs to be sent. In this embodiment, the address information of an associated object that does not need to be sent may be stored in a “negative address number list”, while the address information of an associated object that needs to be sent may be stored in a “positive address number list”.

When the verification result information includes the address information of an associated object that does not need to be sent, the server removes, according to the verification result information, the associated object that does not need to be sent by the client from the associated objects, and determines a remaining associated object as a target associated object.

When the verification result information includes address information of an associated object that needs to be sent, the server confirms, according to the address information of an associated object that needs to be sent, accuracy of the verification result information, and determines a target associated object from the associated objects according to a confirmation result. The confirming the accuracy of the verification result information refers to confirming whether the client really needs the associated object that needs to be sent; when confirming that the client really needs the associated object that needs to be sent, the server selects the associated object needed by the client as a target associated object; when confirming that the client does not really need the associated object that needs to be sent, the server removes the associated object that does not need to be sent to the client from the associated objects, and determines a remaining associated object as a target associated object. As can be seen from this process, compared with a case that the verification result information includes the address information of an associated object that does not need to be sent, in this case, the server needs to verify, according to the verification result information of the client, whether the address information of an associated object that needs to be sent and is sent by the client is accurate, that is, the server determines whether information of an associated object that needs to be sent and is determined by the client is correct.

Step 16: The server sends the target associated object to the client.

After determining the target associated object, the server sends the target associated object to the client. After acquiring the target associated object, the client can acquire a complete requested target object.

As can be seen from the foregoing process, when determining that the object requested by the client has one or more associated objects, the server adds association indication information to the object sent to the client to indicate to the client that the object requested by the client has one or more associated objects. Therefore, different from the prior art where the client needs to request associated objects from the server one by one, after acquiring the association indication information, the client verifies the associated objects according to the verification information of the associated objects of the server, and then the server determines a target associated object according to the verification result information, and sends the target associated object to the client. Therefore, by using the method according to Embodiment 1 of the present invention, the number of requests-responses between the server and the client can be greatly reduced, thereby reducing network data traffic and a network communication delay.

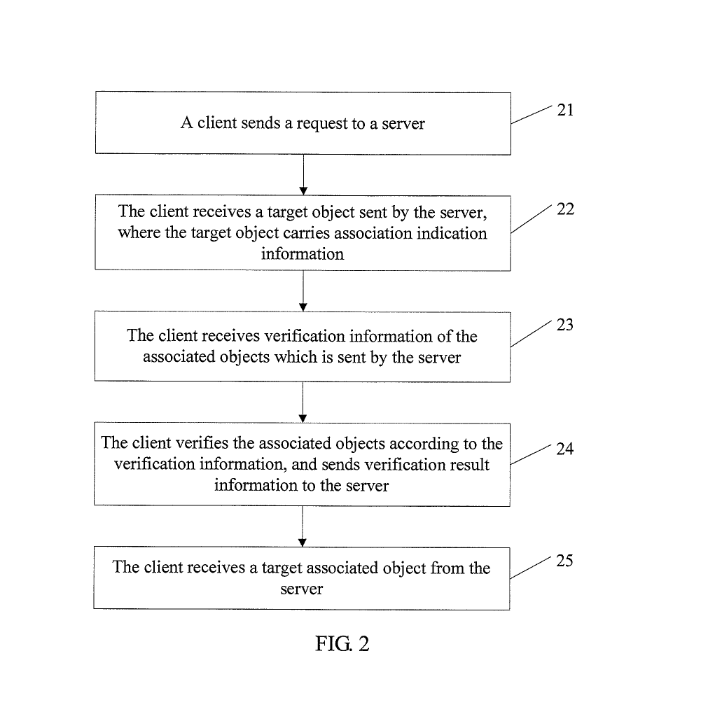

As shown in FIG. 2, a method for acquiring an object according to Embodiment 2 of the present invention includes the following steps:

Step 21: A client sends a request to a server, where the request includes identifier information of a requested target object.

The identifier information of the target object has the same meaning as that described in step 11.

Step 22: The client receives a target object which is sent by the server after the server receives the request, where the target object carries association indication information, where the association indication information is used to indicate that the target object has one or more associated objects.

After receiving the target object sent by the server, the client firstly parses the target object to acquire the association indication information carried in the target object, and then determines that the target object has one or more associated objects.

Step 23: The client receives verification information of the associated objects which is sent by the server.

According to the description in Embodiment 1, the server generally includes the association indication information in a last frame of the target object. Therefore, in this step, when the client determines, by reading the association indication information in the last frame of the target object, that the target object has one or more associated objects, the client does not continue to send a request to the server, but waits for verification information of the associated objects which is sent by the server, so that the client receives the verification information of the associated objects which is sent by the server.

As described in Embodiment 1, the verification information of the associated objects includes address information and relative expiry time of the associated objects.

Step 24: The client verifies the associated objects according to the verification information, and sends verification result information to the server, so that the server determines a target associated object according to the verification result information.

In this step, the client firstly determines, according to the address information of the associated objects, whether the client temporarily stores associated objects corresponding to the address information of the associated objects. If a corresponding associated object is temporarily stored, the client compares a sum of existence time of the corresponding associated object and relative expiry time of the corresponding associated object with a current time; if the sum of the existence time of the corresponding associated object and the relative expiry time of the corresponding associated object is greater than the current time, the client determines that the server does not need to send the corresponding associated object; or if the sum of the existence time of the corresponding associated object and the relative expiry time of the corresponding associated object is less than the current time, the client determines that the server needs to send the corresponding associated object.

Therefore, the verification result information of the client may include the following two types of information: address information of an associated object that does not need to be sent and address information of an associated object that needs to be sent. As described in the foregoing, in this embodiment, the address information of an associated object that does not need to be sent may be stored in a “negative address number list”, while the address information of an associated object that needs to be sent may be stored in a “positive address number list”.

Step 25: The client receives the target associated object sent by the server.

As can be seen from the foregoing process, when determining that the object requested by the client has one or more associated objects, the server adds association indication information to the object sent to the client to indicate to the client that the object requested by the client has one or more associated objects. Therefore, different from the prior art where the client needs to request associated objects from the server one by one, after acquiring the association indication information, the client verifies the associated objects according to the verification information of the associated objects of the server, and then the server determines a target associated object according to the verification result information, and sends the target associated object to the client. Therefore, by using the method according to Embodiment 2 of the present invention, the number of requests-responses between the server and the client can be greatly reduced, thereby reducing network data traffic and a network communication delay.

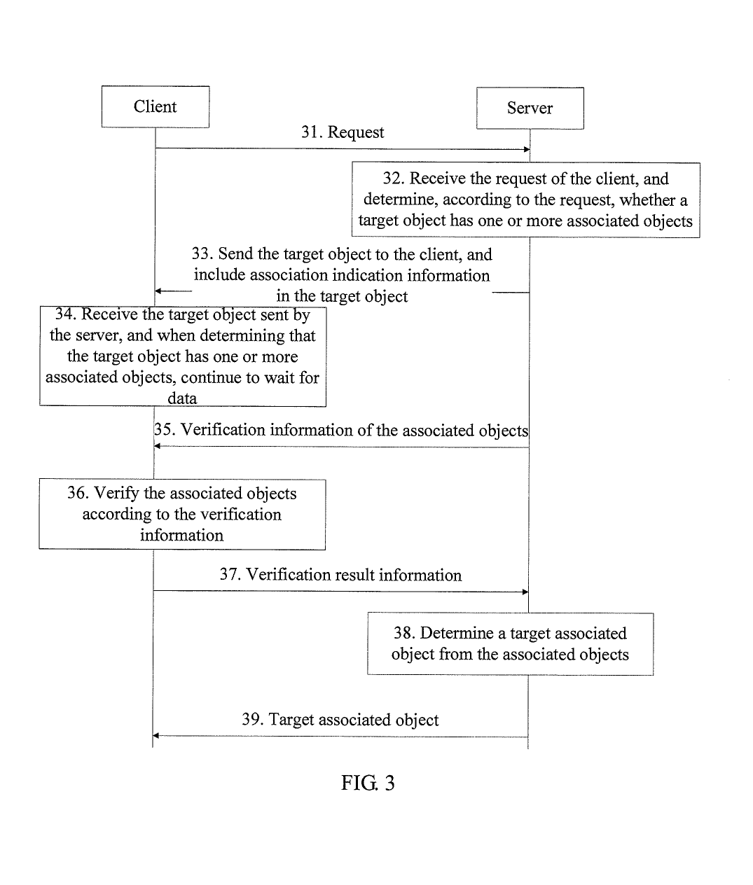

With reference to Embodiment 3, the following describes a specific process of a method for acquiring an object according to the embodiments of the present invention. As shown in FIG. 3, a method for acquiring an object according to Embodiment 3 of the present invention includes the following steps:

Step 31: A client sends a request to a server, where the request includes identifier information of a requested target object.

Step 32: The server receives the request of the client, and determines, according to the request, whether the target object has one or more associated objects.

Step 33: When determining that the target object has one or more associated objects, the server adds association indication information to the target object, and sends the target object to the client, where the association indication information is used to indicate to the client that the target object has one or more associated objects. The association indication information is located in a last frame of the target object.

Step 34: The client receives the target object sent by the server, and when determining that the target object has one or more associated objects according to the association indication information, the client continues to wait for data.

Step 35: The server sends verification information of the associated objects to the client, where the verification information of the associated objects includes address information and relative expiry time of the associated objects.

Step 36: The client receives the verification information of the associated objects which is sent by the server, and verifies the associated objects according to the verification information.

Step 37: The client sends verification result information to the server, where the verification result information includes address information of a corresponding associated object that does not need to be sent by the server.

Step 38: The server determines, according to the verification result information of the client, a target associated object from the associated objects, and removes the associated object that does not need to be sent by the client.

Step 39: The server sends the target associated object to the client.

It should be noted that the foregoing process is an iteration process. When a target associated object sent by the server has other associated objects, the foregoing process may be repeated to send target associated objects of the other associated objects. In addition, the address information and relative expiry time of the associated objects included in the verification information of the associated objects may be sent to the client by using one message or by using two messages.

It can be seen from the above that, by using the method according to Embodiment 3 of the present invention, the number of requests-responses between the server and the client can be greatly reduced, thereby reducing network data traffic and a network communication delay.

In specific applications, the method according to the embodiments of the present invention may be applied to improving the existing hyper text transport protocol (http). A Web application based on the http protocol is one of the most extensively deployed Internet applications. The protocol mainly has the following features: (1) a client needs to send a request to the server to acquire needed data even if the data already exists in a cache of the client; (2) if the client wants to acquire a large quantity of data, for example, 70 files, the client needs to send requests to the server one by one to acquire all the data.

According to the method in the embodiment of the present invention, when a client requests a Web page, a server determines that the Web page requested by the client has a lot of sub-pages that need to be sent to the client. In this case, when responding to the request of the client, the server adds association indication information to a last frame of the Web page data to indicate that the Web page has associated sub-pages, that is, the server will send other files to the client. Then, the server sends an address list and a relative expiry time list of the associated sub-pages to the client. After performing verification according to the address list and the relative expiry time list of the associated sub-pages, the client may return a negative address number list to the server. The server can thereby remove, according to the negative address number list, sub-pages corresponding to negative addresses, and then send other sub-pages to the client. Meanwhile, because the http is not necessarily a permanent connection, the server needs to add a Keep-Alive header field to a header when responding to the request of the client.

Assuming that there are originally 70 requests between the client and the server, by using the method according to the embodiments of the present invention, the requests between the client and the server will be changed to one request of the client and one response to the server, thereby reducing 98 data transmissions from the client to the server.

In addition, the method according to the embodiment of the present invention can also be applied to improving the existing SPDY (speedy, speedy) protocol. The SPDY protocol is a new generation web protocol launched by GOOGLE. A push (push) mechanism is already adopted in the protocol, but no specific implementation process is provided. By using the method according to the embodiment of the present invention, the push mechanism in the SDPY protocol can be well implemented.

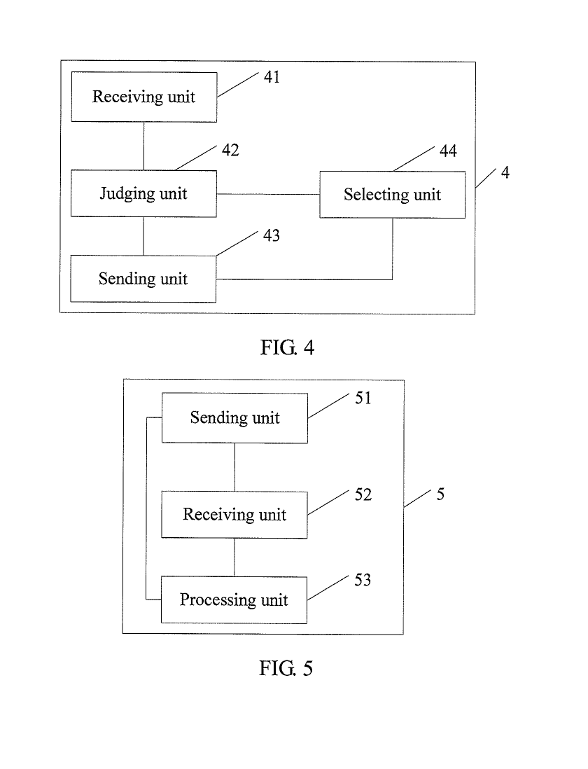

As shown in FIG. 4, a server 4 according to a fourth embodiment of the present invention includes:

a receiving unit 41, configured to receive a request of a client, where the request includes identifier information of a target object requested by the client; a judging unit 42, configured to determine, according to the identifier information of the target object received by the receiving unit 41, whether the target object has one or more associated objects; a sending unit 43, configured to: when the judging unit 42 determines that the target object has one or more associated objects, add association indication information to the target object, and send the target object to the client, so that the client continues to wait for receiving data after receiving the target object; and after finishing sending the target object, send verification information of the associated objects to the client, so that the client verifies the associated objects according to the verification information; and a selecting unit 44, configured to determine, according to verification result information of the client received by the receiving unit 41, a target associated object from the associated objects, where the sending unit 43 is further configured to send the target associated object to the client according to a processing result of the selecting unit 44.

The judging unit 42 may include:

a transferring module, configured to transfer the request to an upper layer application, so that the upper layer application determines, according to the identifier information of the target object, whether to invoke a predetermined interface; a processing module, configured to determine, when the upper layer application invokes the predetermined interface, that the target object has one or more associated objects, and determine, when the upper layer application does not invoke the predetermined interface, that the target object does not have associated objects, where, when the upper layer application determines, according to the identifier information of the target object, that there are associated objects, the upper layer application invokes the predetermined interface; and when the upper layer application determines, according to the identifier information of the target object, that there is no associated object, the upper layer application does not invoke the predetermined interface.

Or, the judging unit 42 may include:

a querying module, configured to query, according to the identifier information of the target object, for an association table used to store information of associated objects of the target object, and a processing module, configured to determine, according to a query result of the querying module, whether the target object has one or more associated objects.

As described in the foregoing method embodiment, the association indication information may be located in a last frame of the target object, and the verification information of the associated objects may include address information and relative expiry time of the associated objects.

The selecting unit 44 may be specifically configured to: when the verification result information includes address information of an associated object that does not need to be sent, remove, according to the verification result information, the associated object that does not need to be sent to the client from the associated objects, and determine a remaining associated object as a target associated object;

or, when the verification result information includes address information of an associated object that needs to be sent, confirm, according to the address information of an associated object that needs to be sent, accuracy of the verification result information, and determine a target associated object from the associated objects according to a confirmation result. The confirming the accuracy of the verification result information refers to confirming whether the client really needs the associated object that needs to be sent; when confirming that the client really needs the associated object that needs to be sent, the selecting unit 44 selects the associated object needed by the client as a target associated object; when confirming that the client does not really need the associated object that needs to be sent, the selecting unit 44 removes the associated object that does not need to be sent to the client from the associated objects, and determines a remaining associated object as a target associated object.

As can be seen from the foregoing description, when determining that the object requested by the client has one or more associated objects, the server adds association indication information to the object sent to the client to indicate to the client that the object requested by the client has one or more associated objects. Therefore, different from the prior art where the client needs to request associated objects from the server one by one, after acquiring the association indication information, the client verifies the associated objects according to the verification information of the associated objects of the server, and then the server determines a target associated object according to the verification result information, and sends the target associated object to the client. Therefore, by using the apparatus according to Embodiment 4 of the present invention, the number of requests-responses between the server and the client can be greatly reduced, thereby reducing network data traffic and a network communication delay.

As shown in FIG. 5, a client 5 according to Embodiment 5 of the present invention includes:

a sending unit 51, configured to send a request to a server, where the request includes identifier information of a requested target object; a receiving unit 52, configured to receive a target object which is sent by the server after the server receives the request, where the target object carries association indication information, where the association indication information is used to indicate that the target object has one or more associated objects; and receive verification information of the associated objects sent by the server; and a processing unit 53, configured to verify the associated objects according to the verification information received by the receiving unit 52, where the sending unit 51 is further configured to send verification result information to the server according to a verification result of the processing unit 53, so that the server determines a target associated object according to the verification result information; and the receiving unit 52 is further configured to receive the target associated object sent by the server.

The verification information of the associated objects includes address information and relative expiry time of the associated objects. The processing unit 53 may include: a detecting module, configured to determine, according to the address information of the associated objects, whether the client temporarily stores corresponding associated objects; a comparing module, configured to: when the detecting module determines that a corresponding associated object is temporarily stored, compare a sum of existence time of the corresponding associated object and relative expiry time of the corresponding associated object with a current time; and a determining module, configured to: when the comparing module determines that the sum of the existence time of the corresponding associated object and the relative expiry time of the corresponding associated object is greater than the current time, determine that the server does not need to send the corresponding associated object; and when the comparing module determines that the sum of the existence time of the corresponding associated object and the relative expiry time of the corresponding associated object is less than the current time, determine that the server needs to send the corresponding associated object.

As described in the foregoing, the verification result information may include address information of a corresponding associated object that does not need to be sent by the server or address information of a corresponding associated object that needs to be sent by the server.

As can be seen from the foregoing description, when determining that the object requested by the client has one or more associated objects, the server adds association indication information to the object sent to the client to indicate to the client that the object requested by the client has one or more associated objects. Therefore, different from the prior art where the client needs to request associated objects from the server one by one, after acquiring the association indication information, the client verifies the associated objects according to the verification information of the associated objects of the server, and then the server determines a target associated object according to the verification result information, and sends the target associated object to the client. Therefore, by using the apparatus according to Embodiment 5 of the present invention, the number of requests-responses between the server and the client can be greatly reduced, thereby reducing network data traffic and a network communication delay.

For details about working principles of the apparatus according to the embodiment of the present invention, reference may be made to the description of the foregoing method embodiments.

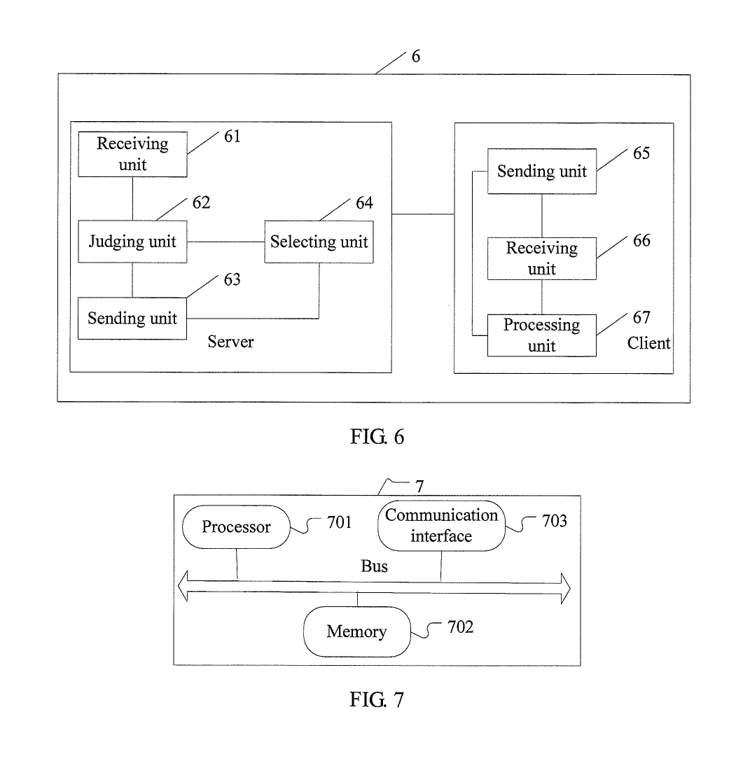

In addition, as shown in FIG. 6, Embodiment 6 of the present invention also provides a system for acquiring an object, including a server and a client. For details about components and working principles of the server, reference may be made to the components and working principles of the server illustrated in FIG. 4; and for details about components and working principles of the client, reference may be made to the components and working principles of the client illustrated in FIG. 5.

FIG. 7 is a schematic structural diagram of a remote control device according to Embodiment 7 of the present invention. As shown in FIG. 7, the remote control device 7 according to this embodiment includes at least one processor 701, a memory 702, a communication interface 703, and a bus. The processor 701, the memory 702, and the communication interface 703 are connected and implement mutual communications through the bus. The bus may be an industry standard architecture (Industry Standard Architecture, ISA for short) bus, a peripheral component interconnect (PCI) bus, an extended industry standard architecture (Extended Industry Standard Architecture, EISA for short) bus, or the like. The bus may be divided into an address bus, a databus, a control bus, and the like. For the ease of illustration, the bus is represented by using only one bold line in FIG. 7, but this does not mean that there is only one bus or only one type of bus.

The memory 702 is configured to store an executable program code, where the program code includes computer operation instructions. The memory 702 may include a high speed RAM memory, and may further include a non-volatile memory, for example, at least one magnetic disk memory.

In one embodiment, the processor 701 runs, by reading the executable program code stored in the memory 702, a program corresponding to the executable program code to:

receive a request of a client, where the request includes identifier information of a target object requested by the client;

determine, according to the identifier information of the target object, whether the target object has one or more associated objects;

when the target object has one or more associated objects, add association indication information to the target object, and send the target object to the client, so that the client continues to wait for receiving data after receiving the target object;

after finishing sending the target object, send verification information to the client, so that the client verifies the associated objects of the target object according to the verification information;

determine, according to verification result information of the client, a target associated object from the associated objects; and

send the target associated object to the client.

In another embodiment, the processor 701 runs, by reading the executable program code stored in the memory 702, a program corresponding to the executable program code to:

send a request to a server, where the request includes identifier information of a requested target object;

receive a target object which is sent by the server after the server receives the request, where the target object carries association indication information, where the association indication information is used to indicate that the target object has one or more associated objects;

receive verification information of the associated objects which is sent by the server;

verify the associated objects according to the verification information, and send verification result information to the server, so that the server determines a target associated object according to the verification result information; and

receive the target associated object sent by the server.

The processor 701 may be a central processing unit (Central Processing Unit, CPU for short), or an application specific integrated circuit (Application Specific Integrated Circuit, ASIC for short), or configured as one or more integrated circuits in the embodiment of the present invention.

It should be noted that, in addition to the foregoing functions, the processor 701 may be further configured to perform other processes in the foregoing method embodiments, which is not further described herein.

The communication interface 703 is mainly configured to implement communications between the device in this embodiment and another device or apparatus.

A person skilled in the art may understand that all or a part of the processes of the methods in the embodiments may be implemented by a computer program instructing relevant hardware. The program may be stored in a computer readable storage medium. When the program runs, the processes of the foregoing methods in the embodiments are performed. The storage medium may be a magnetic disk, an optical disk, a read-only memory (Read-Only Memory, ROM), or a random access memory (Random Access Memory, RAM) or the like.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for acquiring an object, the method comprising:
receiving a request of a client, wherein the request comprises identifier information of a target object requested by the client;
determining, according to the identifier information of the target object, whether the target object has one or more associated objects;
when the target object has one or more associated objects, adding association indication information to the target object, and sending the target object to the client, so that the client continues to wait for receiving data after receiving the target object;
after finishing sending the target object, sending verification information to the client, so that the client verifies the associated objects of the target object according to the verification information;
determining, according to verification result information of the client, a target associated object from the associated objects; and
sending the target associated object to the client.

2. The method according to claim 1, wherein determining, according to the identifier information of the target object, whether the target object has one or more associated objects comprises:
transferring the request to an upper layer application, so that the upper layer application determines, according to the identifier information of the target object, whether to invoke a predetermined interface; and
determining, according to an invocation situation of the predetermined interface, whether the target object has one or more associated objects.

3. The method according to claim 1, wherein determining, according to the identifier information of the target object, whether the target object has one or more associated objects comprises:
querying, according to the identifier information of the target object, for an association table used to store information of associated objects of the target object, and determining, according to a query result, whether the target object has one or more associated objects.

4. The method according to claim 1, wherein the association indication information is located in a last frame of the target object.

5. The method according to claim 1, wherein the verification information comprises address information and relative expiry time of the associated objects.

6. The method according to claim 1, wherein:
the verification result information comprises address information of an associated object that does not need to be sent; and
determining, according to verification result information of the client, a target associated object from the associated objects comprises:
removing, according to the verification result information, the associated object that does not need to be sent to the client from the associated objects, and determining a remaining associated object as a target associated object.

7. The method according to claim 1, wherein:
the verification result information comprises address information of an associated object that needs to be sent; and
determining, according to verification result information of the client, a target associated object from the associated objects comprises:
confirming, according to the address information of the associated object that needs to be sent, accuracy of the verification result information, and determining a target associated object from the associated objects according to a confirmation result.

8. A method for acquiring an object, the method comprising:
sending a request to a server, wherein the request comprises identifier information of a requested target object;
receiving a target object which is sent by the server after the server receives the request, wherein the target object carries association indication information, wherein the association indication information is used to indicate that the target object has one or more associated objects;
receiving verification information of the associated objects which is sent by the server;
verifying the associated objects according to the verification information, and sending verification result information to the server, so that the server determines a target associated object according to the verification result information; and
receiving the target associated object sent by the server.

9. The method according to claim 8, wherein the verification information of the associated objects comprises address information and relative expiry time of the associated objects; and
verifying the associated objects according to the verification information comprises:
determining, according to the address information of the associated objects, whether a corresponding associated object is temporarily stored locally, and
if a corresponding associated object is temporarily stored locally and a sum of existence time of the corresponding associated object and relative expiry time of the corresponding associated object is greater than a current time, determining that the server does not need to send the corresponding associated object; or
if a corresponding associated object is temporarily stored locally and a sum of existence time of the corresponding associated object and relative expiry time of the corresponding associated object is less than a current time, determining that the server needs to send the corresponding associated object.

10. The method according to claim 8, wherein the verification result information comprises:
address information of a corresponding associated object that does not need to be sent by the server or address information of a corresponding associated object that needs to be sent by the server.

11. A server, comprising:
a receiving unit, configured to receive a request of a client, wherein the request comprises identifier information of a target object requested by the client;
a judging unit, configured to determine, according to the identifier information of the target object received by the receiving unit, whether the target object has one or more associated objects;
a sending unit, configured to: when the judging unit determines that the target object has one or more associated objects, add association indication information to the target object, and send the target object to the client, so that the client continues to wait for receiving data after receiving the target object; and after finishing sending the target object, send verification information to the client, so that the client verifies the associated objects of the target object according to the verification information; and
a selecting unit, configured to determine a target associated object from the associated objects according to verification result information of the client received by the receiving unit; wherein:
the sending unit is further configured to send the target associated object to the client according to a processing result of the selecting unit.

12. The server according to claim 11, wherein the judging unit comprises:
a transferring module, configured to transfer the request to an upper layer application, so that the upper layer application determines, according to the identifier information of the target object, whether to invoke a predetermined interface; and
a processing module, configured to determine, when the upper layer application invokes the predetermined interface, that the target object has one or more associated objects, and determine, when the upper layer application does not invoke the predetermined interface, that the target object does not have associated objects, wherein, when the upper layer application determines, according to the identifier information of the target object, that there are associated objects, the upper layer application invokes the predetermined interface; and when the upper layer application determines, according to the identifier information of the target object, that there is no associated object, the upper layer application does not invoke the predetermined interface.

13. The server according to claim 11, wherein the judging unit comprises:
a querying module, configured to query, according to the identifier information of the target object, for an association table used to store information of associated objects of the target object; and
a processing module, configured to determine, according to a query result of the querying module, whether the target object has one or more associated objects.

14. The server according to claim 11, wherein the selecting unit is configured to:
when the verification result information comprises address information of an associated object that does not need to be sent, remove, according to the verification result information, the associated object that does not need to be sent to the client from the associated objects, and determine a remaining associated object as a target associated object;
or, when the verification result information comprises address information of an associated object that needs to be sent, confirm, according to the address information of an associated object that needs to be sent, accuracy of the verification result information, and determine a target associated object from the associated objects according to a confirmation result.

15. A client, comprising:
a sending unit, configured to send a request to a server, wherein the request comprises identifier information of a requested target object;
a receiving unit, configured to receive a target object which is sent by the server after the server receives the request, wherein the target object carries association indication information, wherein the association indication information is used to indicate that the target object has one or more associated objects; and receive verification information of the associated objects sent by the server;
a processing unit, configured to verify the associated objects according to the verification information received by the receiving unit; and
wherein:
the sending unit is further configured to send verification result information to the server according to a verification result of the processing unit, so that the server determines a target associated object according to the verification result information, and
the receiving unit is further configured to receive the target associated object sent by the server.

16. The client according to claim 15, wherein the verification information of the associated objects comprises address information and relative expiry time of the associated objects; and
the processing unit comprises:
a detecting module, configured to determine, according to the address information of the associated objects, whether the client temporarily stores a corresponding associated object,
a comparing module, configured to: when the detecting module determines that a corresponding associated object is temporarily stored, compare a sum of existence time of the corresponding associated object and relative expiry time of the corresponding associated object with a current time, and
a determining module, configured to: when the comparing module determines that the sum of the existence time of the corresponding associated object and the relative expiry time of the corresponding associated object is greater than the current time, determine that the server does not need to send the corresponding associated object; and when the comparing module determines that the sum of the existence time of the corresponding associated object and the relative expiry time of the corresponding associated object is less than the current time, determine that the server needs to send the corresponding associated object.

17. The client according to claim 15, wherein the verification result information comprises:
address information of a corresponding associated object that does not need to be sent by the server or address information of a corresponding associated object that needs to be sent by the server.

18. A system for acquiring an object, comprising:
a server and a client, wherein:
the server is configured to receive a request of the client, wherein the request comprises identifier information of a target object requested by the client; determine, according to the identifier information of the target object, whether the target object has one or more associated objects; when determines that the target object has one or more associated objects, add association indication information to the target object, and send the target object to the client, and after finishing sending the target object, send verification information to the client,
the client is configured to receive the target object and verification information which is sent by the server, verify the associated objects according to the verification information received by the receiving unit, and send verification result information to the server according to a verification result;
the server is further configured to determine a target associated object according to the verification result information and send the target associated object to the client.

19. A server, comprising a processor and a non-transitory processor-readable memory, the processor and the memory being connected through a bus, the memory being configured to store an executable program code; the processor being configured to read the executable program code stored in the memory so as to:
receive a request of a client, wherein the request comprises identifier information of a target object requested by the client;
determine, according to the identifier information of the target object, whether the target object has one or more associated objects;
when the target object has one or more associated objects, add association indication information to the target object, and send the target object to the client, so that the client continues to wait for receiving data after receiving the target object;
send verification information to the client, so that the client verifies the associated objects of the target object according to the verification information;
determine, according to verification result information of the client, a target associated object from the associated objects; and
send the target associated object to the client.

20. A client, comprising a processor and a non-transitory processor-readable memory, the processor and the memory being connected through a bus, the memory being configured to store an executable program code; the processor being configured to read the executable program code stored in the memory so as to:
send a request to a server, wherein the request comprises identifier information of a requested target object;
receive a target object which is sent by the server after the server receives the request, wherein the target object carries association indication information, wherein the association indication information is used to indicate that the target object has one or more associated objects;
receive verification information of the associated objects which is sent by the server;
verify the associated objects according to the verification information, and sending verification result information to the server, so that the server determines a target associated object according to the verification result information; and
receive the target associated object sent by the server.
